(19) United States
(12) Patent Application Publication
(10) Pub. No.: US 2012/0039445 A1
(43) Pub. Date: Feb. 16, 2012

(54) Modular Fixed Beam-Limiting Device For Intraoral X-Ray System

(75) Inventors: Arkady Kantor, Buffalo Grove, IL (US); Lyubomir Cekov, Rolling Meadows, IL (US)

(73) Assignee: MIDMARK CORPORATION, Versailles, OH (US)

(21) Appl. No.: 13/208,904

(22) Filed: Aug. 12, 2011

Related U.S. Application Data
(60) Provisional application No. 61/373,101, filed on Aug. 12, 2010.

(51) Int. Cl. G21K 1/02

(52) U.S. Cl. 378/147

(57) ABSTRACT

A modular beam-limiting device for use with an x-ray machine includes a base portion and an attachment portion. The base portion includes at least one magnet. The attachment portion includes at least one magnet. The base portion is adapted to be received on an x-ray tubehead housing. The attachment portion is selectively removably couplable to said base portion. The modular beam-limiting device may further include a magnetic field modulator, which is operable to shape a magnetic field; an insert for configuring a size, a shape, or an orientation of an aperture of the beam-limiting device; or an adapter for increasing an axial length of the beam-limiting device.

### CROSS REFERENCE TO RELATED APPLICATIONS

This application claims the benefit of U.S. Provisional Application No. 61/373,101, filed Aug. 12, 2010, which is hereby incorporated by reference herein in its entirety.

### FIELD OF THE INVENTION

This invention relates to a radiation protection device that protects patients, as well as clinical staff against excessive x-ray radiation exposure by controlling the x-ray field of exposure.

### BACKGROUND

X-radiation (containing x-rays) is a form of electromagnetic radiation having a multitude of applications. One commonly used application is found in medical diagnostics, such as dental or bone imaging. Thus, while x-ray radiation is useful for medical purposes, the x-ray radiation can be harmful to the human body. As such, overexposure to x-ray radiation should be minimized. One approach to controlling exposure is to limit the x-ray field of exposure by using beam-limiting devices, also known as collimators. Traditionally, beam limiting devices have been available as either variable-aperture beam-limiting devices, or as a set of interchangeable fixed beam-limiting devices. While those configurations provide solutions for various geometric environments, they can also result in a large assortment of parts, difficulty of use, and higher cost.

Some conventional intraoral x-ray systems provide multiple interchangeable fixed beam-limiting devices. In these systems, the beam-limiting device body is generally made of an x-ray opaque high-density material, such as Nylon 6/6, filled with barium sulfite powder. The body of the beam-limiting device may include grooves, which accommodate O-rings to provide a snap fit with the x-ray tube housing. Special attachments may be used to provide appropriate shaping of the x-ray beam.

Conventional fixed beam-limiting devices are available in various shapes that may be suitable for various medical studies. However, the number of different versions of beam-limiting devices is growing based on radiation regulations, which may be dissimilar in different countries. One drawback of conventional intraoral x-ray systems is that the field replacement of the beam-limiting device requires additional effort and special tools. In addition, conventional designs do not facilitate easy adjustment in order to match a shaped opening (such as a rectangular opening) with the x-ray film or sensor being used.

In view of the foregoing, a need exists for beam-limiting devices, such as those used with x-ray systems, that overcome the short-comings of conventional beam-limiting devices.

### SUMMARY

The present invention overcomes the foregoing and other shortcomings and drawbacks of beam-limiting devices heretofore known for use in x-ray systems. While various embodiments are discussed in detail herein, it will be understood that the invention is not limited to these embodiments. On the contrary, the invention includes all alternatives, modifications and equivalents as may be included within the spirit and scope of the present invention.

In accordance with one embodiment, a modular beam-limiting device for use with an x-ray machine is provided that includes a base portion having a tubular body adapted to be received on an x-ray tubehead housing, an attachment portion having a tubular body selectively removably couplable to the base portion, at least one first magnet on the base portion, and at least one second magnet or magnetically attractive material on the attachment portion.

In accordance with another embodiment, method of securing a modular beam-limiting device to an x-ray machine is provide, the method including the steps of coupling a base portion on an x-ray tubehead housing, wherein the base portion includes at least one first magnet; and selectively removably coupling an attachment portion to the base portion, wherein the attachment portion includes at least one second magnet. The at least one first magnet and the at least one second magnet are polarized in complementary orientations such that the attachment portion is coupled to the base portion by magnetic force.

### BRIEF DESCRIPTION OF THE DRAWINGS

FIG. 1 is a perspective view of an x-ray system including an x-ray machine having a beam-limiting device according to an embodiment of the present invention.

FIG. 2 is a cross-sectional view of an x-ray machine including an exemplary modular beam-limiting device in accordance with the principles of the present invention.

FIG. 2A is an enlarged view of the encircled area shown in FIG. 2.

FIG. 3 is an exploded perspective view of the exemplary beam-limiting device of FIG. 2.

FIGS. 4A-4B are perspective views depicting a method of aligning a base portion and an attachment portion of an exemplary beam-limiting device in accordance with the principles of the present invention.

FIG. 5 is an exploded perspective view of another exemplary beam-limiting device in accordance with the principles of the present invention.

FIG. 6 is an exploded perspective view of another exemplary beam-limiting device in accordance with the principles of the present invention.

### DETAILED DESCRIPTION

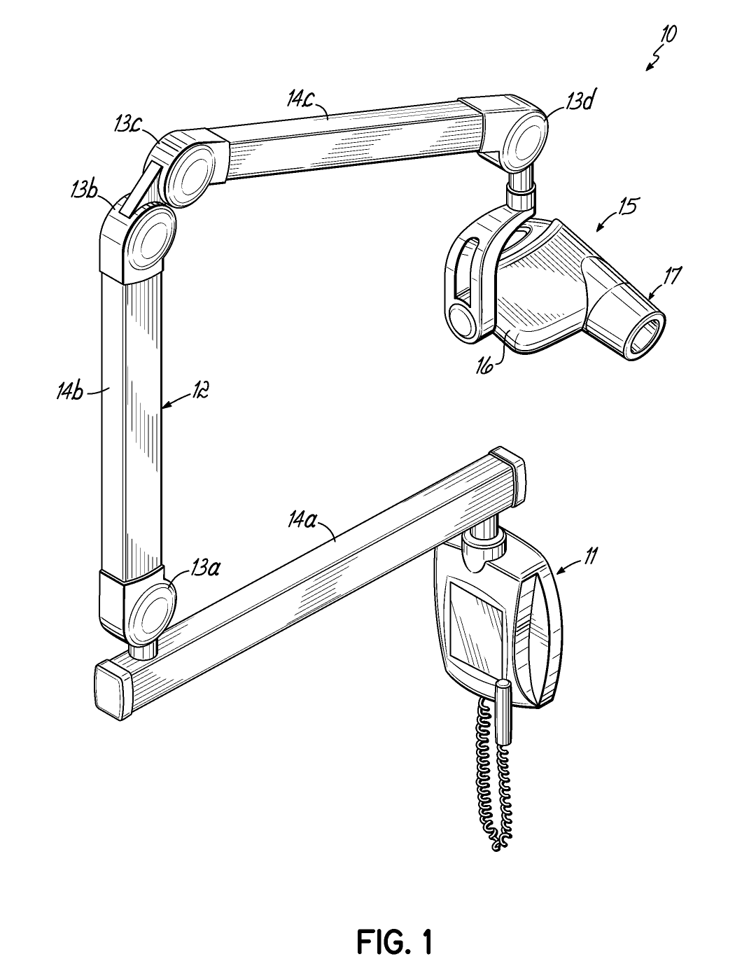

FIG. 1 depicts an exemplary embodiment of an x-ray system 10 that includes a control station 11, a jointed arm construction 12 including articulating joints 13A-D and arms 14A-C, and an x-ray machine 15 having a housing 16 and a modular beam-limiting device 17 in accordance with the principles of the present invention. According to various embodiments, the modular beam-limiting device 17 is not restricted to any particular x-ray machine 15 insofar as the modular beam-limiting device 17 may be adapted to conform to any x-ray machine, without limitation.

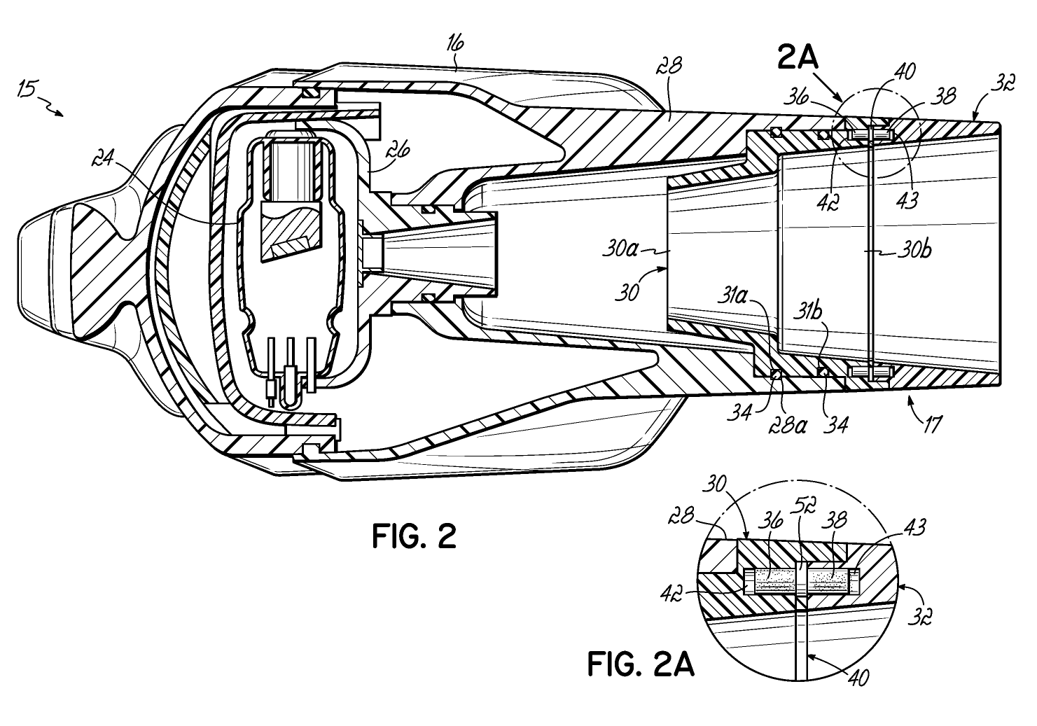

With reference to FIG. 2, a cross-sectional view is provided of the x-ray machine 15 that may be used with an intraoral x-ray system. In the embodiment shown, an x-ray tube 24, an x-ray shield 26, and a tubehead housing 28 are disposed within the x-ray machine housing 16. The modular beam-limiting device 17 includes a base portion 30 and an attachment portion 32, each having magnets 36, 38.

The base portion 30, which provides support to other components (e.g., the attachment portion 32) has a tubular construction and is adapted to be received on the x-ray tubehead housing 28. The tubehead housing 28 may also include an internal groove 28a. More specifically, relative to the x-ray tube 24, the base portion 30 includes a proximal end 30a and a distal end 30b; the proximal end 30a being received in opening of the tubehead housing 28. O-rings 34, which are provided on outer surface of the base portion 30 near the proximal end 30a, are received in circumferential grooves 31a, 31b and provide frictional engagement to couple the base portion 32 with the tubehead housing 28. Grooves 28a and 31a each accommodate a portion of an O-ring thereby providing a snap fit. While the embodiments shown and described herein utilize O-rings to facilitate coupling the base portion 30 to tubehead housing 28, it will be appreciated that various other methods and structure may alternatively be used. For example, in alternative embodiments, other coupling configurations, which may include screws, pins, threads, or other suitable structure, may be utilized in addition to, or instead of, the O-rings 34 to retain the base portion 30 coupled to the tubehead housing 28. Distal end 30b of the base portion 30 includes magnets 36.

The attachment portion 32 is selectively removably couplable to the base portion 30 for easy removal and replacement and provides the desired collimation of x-ray radiation. The attachment portion 32 includes magnets 38, which are polarized in a complementary orientation to magnets 36, such that the attachment portion 32 is magnetically coupled with the base portion 30 when the attachment portion 32 is placed in proximity to the base portion 30 and magnets 36, 38 are aligned to at least one distinct angular orientation. Magnets 36, 38 are of sufficient strength to provide enough magnetic attractive force to hold in place the base portion 30 and the attachment portion 32. As shown, the magnets 36, 38 are cylindrically formed and may be axially magnetized. It will be appreciated, however, that various other shapes and configurations, including but not limited to cubic or rectangular shapes, may be used.

While the embodiments shown and described herein include magnets on both the base portion 30 and the attachment portion 32, it will be appreciated that various other configurations may alternatively be used. As a non-limiting example, an alternative embodiment may comprise at least one magnet provided in one of the base portion 30 or the attachment portion 32, and a ferromagnetic substance or a substance that is attracted to a magnet provided on the other of the base portion 30 or the attachment portion 32, whereby the magnet and the ferromagnetic or magnetically attracted substance provide for coupling of the base portion 30 and the attachment portion 32 in a manner similar to that described above.

According to embodiments of the invention, the base portion 30 and the attachment portion 32 may comprise one or more x-ray opaque high-density materials, such as Nylon 6/6 filled with barium sulfite powder. The magnets 36, 38 may be incorporated into the base portion 30 and the attachment portion 32 using standard molding techniques. Alternatively, the magnets 36, 38 may be added to the base portion 30 and/or the attachment portion 32 after the base portion 30 or attachment portion 32 have been made. For example, as shown in FIG. 2A, magnets 36, 38 may be press-fitted into bores, as indicated by voids 42, 43. Various other methods may also be used.

Still referring to FIG. 2, the modular beam-limiting device may further include a magnetic field modulator 40 that modifies magnetic fields of the magnets 36, 38 in such way that the magnetic force distribution holds the attachment portion 32 in one or more distinct orientation positions relative to the base portion 30. The magnetic field modulator 40 therefore facilitates easy positioning in order that an operator of the x-ray device 10 may adjust the orientation of an aperture of the modular beam-limiting device 17 with respect to an x-ray film or a sensor. The magnetic field modulator 40 can be made from any material suitable for modifying or shaping the magnetic field generated by the magnets 36, 38 so that distinct

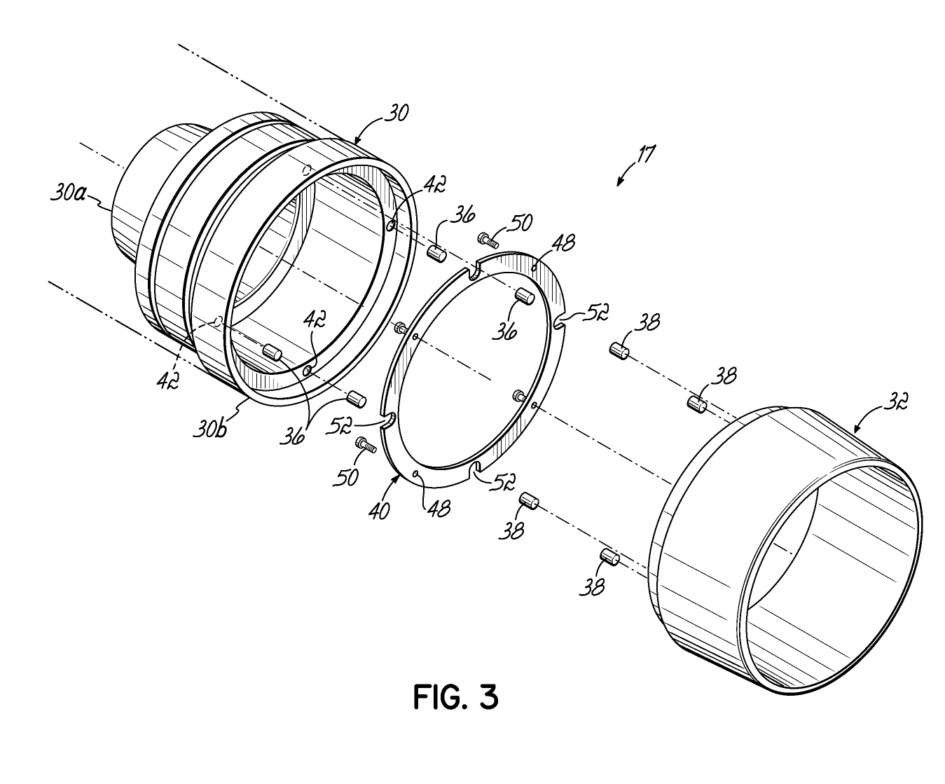

The magnetic field modulator 40 may be formed integrally with the base portion 30 or the attachment portion 32, such as by molding therewith. Alternatively, the modulator 40 may be coupled with the base portion 30 or the attachment portion 32 after the portion has been formed. For example, FIG. 3 depicts an embodiment having openings 48 in a ring-shaped magnetic field modulator 40 to accommodate studs 50 to thereby attach the modulator 40 to the attachment portion 32. The studs 50 may be used to secure the ring to the attachment portion during molding, or may be used to attach the ring to the attachment portion 32 after the portion has been formed. Accordingly, other methods, such as adhesive bonding or mechanical coupling, may alternatively be used to attach the modulator 40 to the attachment portion 32. While this embodiment depicts a modular beam-limiting device 20 wherein a magnetic field modulator 40 is provided on the attachment portion 32 of the device 17, it will be appreciated that other embodiments may have a magnetic field modulator 40 provided on the base portion 30, or provided on both the base and attachment portions 30, 32.

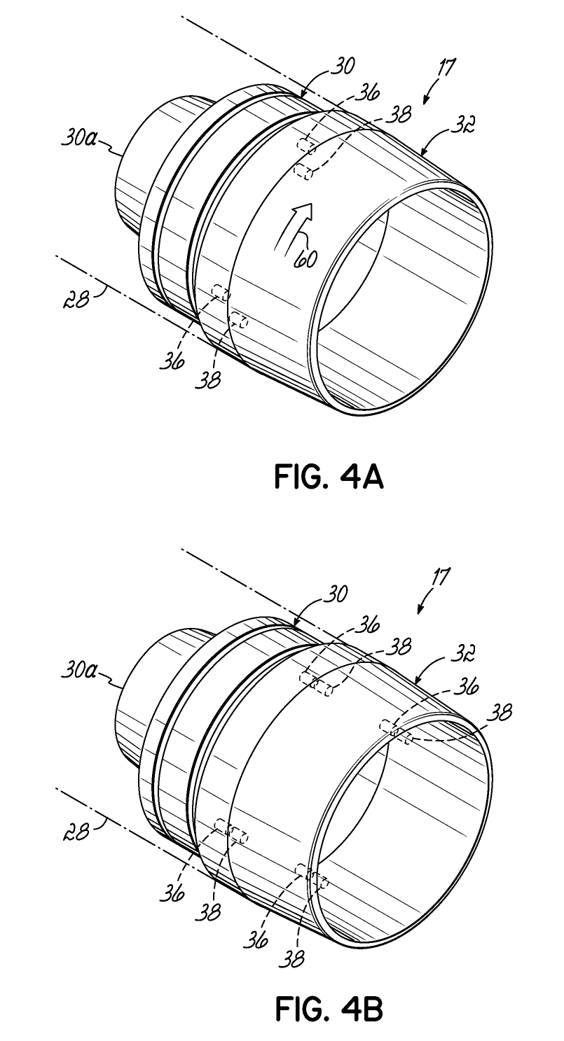

With continued reference to FIG. 3, and referring further to FIG. 4, four magnets 36 are provided on the base portion 30 of the beam-limiting device 17, and four corresponding magnets 38 are provided on the attachment portion 32 of the beam-limiting device 17. While four magnets are used for each of the base and attachment portions 30, 32, it will be appreciated that various other configurations of magnets may alternatively be used, and which may include more than four magnets, or fewer than four magnets on one or both of the attachment and base portions 30, 32 of the modular beam-limiting device 17. The attachment portion 32 of the modular beam-limiting device 17 in accordance with the principles of the present invention may be easily removed and replaced in the field.

In the embodiment shown in FIG. 3, the magnetic field modulator 40 comprises an annular ring formed from a material suitable for shaping the magnetic field produced by the magnets. Notches 52 are provided at spaced intervals around the circumference of the rings. The notches 52 create discontinuities in the magnetic field that can be sensed by a user when an attachment portion 32 is coupled with the base portion 30 and rotated to different angular positions. As shown in FIG. 4A, where magnets 36, 38 are not aligned with respect to each other, the magnetic field may provide a noticeably reduced retaining force. Upon rotation of the attachment portion 32 in the direction designated by an arrow 60, the magnets 36, 38 become aligned as shown in FIG. 4B thereby maximizing the magnetic force and defining at least one predetermined orientation of the base and attachment portions 30, 32. It will be appreciated that magnetic field modulators 40 in accordance with the principles of the present invention may alternatively be formed in shapes other than annular rings, and may utilize various other structural features to shape the magnetic field generated by the magnets, as may be desired.

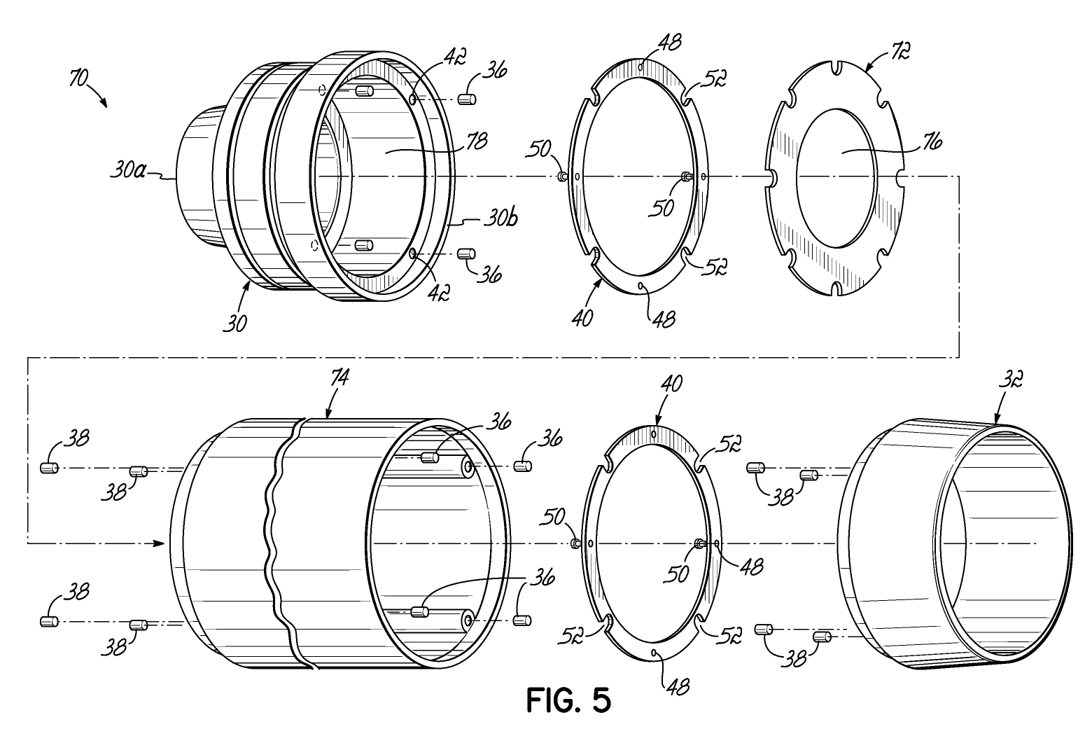

The beam-limiting device 17 may further include additional components, such as inserts for modifying an aperture of the device 20 and/or an adapter for converting the beam-limiting device 17 to have a longer axial length. The insert and the adapter may be constructed of x-ray opaque high-density materials, such as those materials suitable for use in the base portion 30 and the attachment portion 32. Accordingly, FIG. 5 depicts an exemplary modular beam-limiting device 70 including an insert 72 and an adapter 74. The insert 72 may be received between the base portion 30 and the attachment portion 32, whereby the insert 72 can be easily removed and replaced, as may be desired. The insert 72 may be formed in an annular ring having an aperture 76 that is less than the base portion aperture 78 to thereby reduce the size of the x-ray beam pathway. The adapter 74 may be used to convert the axial length of the beam-limiting device 70 to the desired dimension. For example, the axial length may be increased from about 200 mm to about 300 mm. In this embodiment, magnets 36, 38 and magnetic field modulators 40 as described above are provided at the interface between the base portion 30 and the insert 72, as well as at the interface between the adapter 74 and the attachment portion 32.

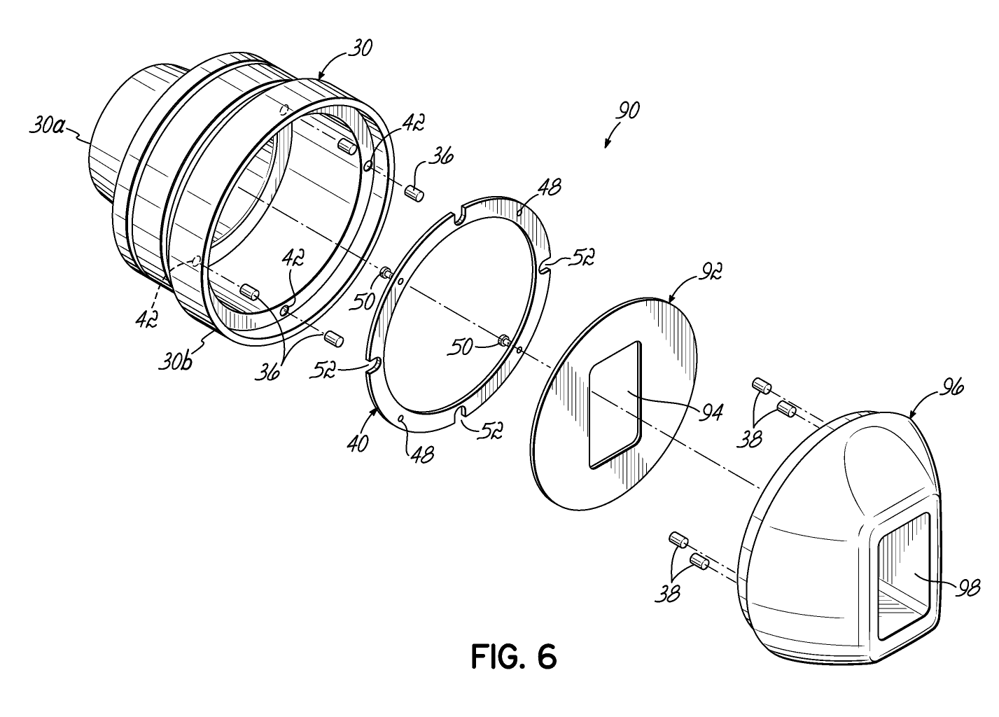

FIG. 6 depicts yet another exemplary embodiment of a beam-limiting device 90 including an insert 92 configured to have a rectangular-shaped aperture 94. The attachment portion 96 may also have a rectangular-shaped aperture 98. Accordingly, the rectangular-shaped apertures 96, 98 may be aligned. In this embodiment, magnets 36, 38 and a magnetic field modulator 40 as described above are provided at the interface between the base portion 30 and the attachment portion 96.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. The various features of exemplary embodiments described herein may be used in any combination. Accordingly, departures may be made from such details without departing from the scope or spirit of Applicant's general inventive concept.

What is claimed is:

1. A modular beam-limiting device for use with an x-ray machine, comprising:
a base portion having a tubular body adapted to be received on an x-ray tubehead housing;
an attachment portion having a tubular body selectively removably coupled to said base portion;
at least one first magnet on said base portion; and
at least one magnetically attractive member on said attachment portion and cooperating with said at least one first magnet to retain said attachment portion on said base portion.

2. The modular beam-limiting device of claim 1, wherein said at least one first magnet and said at least one magnetically attractive member cooperate to define at least one distinct angular orientation of said attachment portion relative to said base portion when said attachment portion is coupled to said base portion.

3. The modular beam-limiting device of claim 1, wherein said at least one magnetically attractive member is at least one second magnet.

4. The modular beam-limiting device of claim 3, further comprising:
a magnetic field modulator on at least one of said base portion or said attachment portion;
said magnetic field modulator shaping a magnetic field produced by said at least one first magnet or said at least one second magnet.

5. The modular beam-limiting device of claim 4, wherein said magnetic field modulator shapes said magnetic field such that at least one distinct angular orientation of said attachment relative to said base portion is defined by said magnetic field.

6. The modular beam-limiting device of claim 4, wherein said magnetic field modulator comprises at least one structural variation that shapes said magnetic field.

7. The modular beam-limiting device of claim 6, wherein said structural variation is a notch.

8. The modular beam-limiting device of claim 4, wherein said magnetic field modulator is annular shaped and comprises a plurality of notches at spaced intervals around a periphery of said magnetic field modulator.

9. The modular beam-limiting device of claim 1, further comprising:
an insert received between said base portion and said attachment portion;
said insert configured to change at least one of a size, a shape, or an orientation of an aperture of said beam-limiting device.

10. The modular beam-limiting device of claim 3, further comprising:
an adapter having a first end and a second end;
at least one third magnet on said first end; and
at least one fourth magnet on said second end;
said adapter removably couplable between said base portion and said attachment portion to thereby increasing an axial length of said beam-limiting device.

11. The modular beam-limiting device of claim 10, further comprising:
at least one magnetic field modulator disposed between said adapter and at least one of said base portion or said attachment portion;
said magnetic field modulator shaping at least one of a magnetic field produced by at least one of said first magnet, said second magnet, said third magnet, or said fourth magnet.

12. The modular beam-limiting device of claim 10, further comprising:
an insert received between said adapter and at least one of said base portion or said attachment portion;
said insert configured to change at least one of a size, a shape, or an orientation of an aperture of said beam-limiting device.

13. A method of securing a beam-limiting device to an x-ray machine, the method comprising:
coupling a base portion of the beam limiting device with an x-ray tubehead housing, wherein the base portion includes at least one first magnet; and
selectively removably coupling an attachment portion of the beam limiting device to the base portion, wherein the attachment portion includes at least one magnetically attractive member;
the at least one first magnet and the at least one magnetically attractive member cooperating such that the attachment portion is coupled to the base portion by magnetic force.

14. The method of claim 13, wherein the at least one magnetically attractive member is at least one second magnet.

15. The method of claim 13, further comprising:
adjusting the attachment portion relative to the base portion from a first angular orientation to a second angular orientation;
the first magnet and the magnetically attractive member cooperating to define at least the second angular orientation.

16. The method of claim 14, further comprising:
shaping a magnetic field produced by the at least one first magnet or the at least one second magnet to define at least one distinct angular orientation between the at least one first magnet or the at least one second magnet.

17. The method of claim 16, wherein shaping the magnetic field comprises positioning at least one magnetic field modulator between the base portion and the attachment portion.

18. The method of claim 17, wherein the magnetic field modulator is fixed to at least one of the base portion or the attachment portion.

19. The method of claim 13, further comprising:
configuring at least one of a size, a shape, or an orientation of an aperture of the beam-limiting device by positioning an insert between the base portion and the attachment portion.

20. The method of claim 13, further comprising:
increasing an axial length of the beam-limiting device by removably coupling an adapter to the base portion and the attachment portion;
the adapter having a first end and a second end, and having at least one magnet on each of the first and second ends.

21. The method of claim 20, further comprising:
shaping a magnetic field between at least one of:
a) the base portion and the adapter, or between
b) the attachment portion and the adapter;
wherein shaping the magnetic field comprises positioning at least one magnetic field modulator at an interface between the adapter and at least one of the base portion or the attachment portion.

22. The method of claim 20, further comprising:
configuring at least one of a size, a shape, or an orientation of an aperture of the beam-limiting device by positioning an insert at an interface between the adapter and at least one of the base portion or the attachment portion.
